(19) United States
(12) Patent Application Publication
(10) Pub. No.: US 2013/0346394 A1
(43) Pub. Date: Dec. 26, 2013

(54) VIRTUAL TREE

(71) Applicant: Schlumberger Technology Corporation, Sugar Land, TX (US)

(72) Inventors: Hallgrim Ludvigsen, Stavanger (NO); Trond Benum, Trondheim (NO)

(21) Appl. No.: 13/917,985

(22) Filed: Jun. 14, 2013

Related U.S. Application Data
(60) Provisional application No. 61/662,298, filed on Jun. 20, 2012.

(51) Int. Cl. G06F 17/30

(52) U.S. Cl. CPC G06F 17/30554
USPC 707/722

(57) ABSTRACT

A method can include receiving search results for a search of data based on search criteria; structuring the search results in a hierarchical tree structure defined by at least one structuring criterion; rendering a graphical control to a display that comprises a graphic of at least a portion of the hierarchical tree structure; and navigating the search results by interacting with the graphical control. Various other apparatuses, systems, methods, etc., are also disclosed.

### RELATED APPLICATIONS

This application claims the benefit of U.S. Provisional Patent Application having Ser. No. 61/662,298, filed 20 Jun. 2012, which is incorporated by reference herein.

### BACKGROUND

Various types of modules, frameworks, etc., exist for modeling, analyzing, etc., geological formations, reservoirs, sedimentary basins, etc. Various examples of methods, devices, systems, etc., are described herein that may pertain to such technologies.

### SUMMARY

One or more computer-readable storage media can include computer-executable instructions to instruct a computing system to: receive search results for a search of data based on search criteria; structure the search results in a hierarchical tree structure defined by at least one structuring criterion; render a graphic of at least a portion of the hierarchical tree structure to a display; responsive to redefinition of the hierarchical tree structure, restructure the search results; and render a graphic of at least a portion of the redefined hierarchical tree structure to the display. A method can include receiving search results for a search of data based on search criteria; structuring the search results in a hierarchical tree structure defined by at least one structuring criterion; rendering a graphical control to a display that comprises a graphic of at least a portion of the hierarchical tree structure; and navigating the search results by interacting with the graphical control. A system can include one or more processors; memory; and instructions stored in the memory and executable by at least one of the one or more processors to instruction the system to receive search results for a search of data based on search criteria, render a graphical control to a display for at least a first level of a hierarchical tree structure defined by structuring criteria and, responsive to selection of the graphical control, render one or more additional graphical controls to the display as one or more branches of the hierarchically tree structure wherein each of the one or more branches is defined by one of the structuring criteria. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example system that includes various components for simulating a geological environment;

FIG. 2 illustrates an example of a system;

FIG. 3 illustrates an example of a method;

FIG. 4 illustrates an example of a graphical user interface;

FIG. 5 illustrates an example of a graphical user interface;

FIG. 6 illustrates an example of a graphical user interface;

FIG. 7 illustrates an example of a method;

FIG. 8 illustrates an example of a system;

FIG. 9 illustrates an example, of a method;

FIG. 10 illustrates an example of a method; and

FIG. 11 illustrates example components of a system and a networked system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

Resource exploration and development as well as production can include data acquisition and modeling. For example, a model of a geologic environment may be built based at least in part on acquired data. As an example, such a model may be a simulation model, for example, to simulate one or more physical phenomena. As an example, a model may be a way of structuring data, for example, where such data may facilitate economic or other analyses (e.g., optionally without simulation of physical phenomena). Whether for simulation or other purpose, data associated with a model may be considerable and may, for example, include data associated with one or more other models. As an example, data may be quantitative, qualitative or both quantitative and qualitative. As an example, data may be stored in one or more data stores, which may be considered data sources. As an example, data may be communicated (e.g., transmitted) optionally without storage in a data store. As an example, consider a field sensor that transmits data continuously, periodically or on-demand. Such a sensor may be considered as providing data and thereby be a data source.

As an example, the value of data may be enhanced via aggregation, classification, etc. As an example, data may have one or more associated attributes that characterize the data, for example, consider data characterized by type of data (e.g., sensor data, simulation data, economic data, etc.). In such an example, data may be characterized, for example, in addition to including values, which may be qualitative, quantitative, etc. As an example, a search engine may be configured to access data based on one or more values, attributes, etc. For example, a search engine may perform a search based at least in part on indexed data values, data attributes, etc., which may facilitate searches. For example, an index or indexes may be generated for data, optionally where the data may be available from multiple sources, where the data includes data available from multiple sources, etc.

As an example, search results returned by a search engine that performs a search based on one or more search criteria may be presented as items in a table, for example, as items of a list. In such an example, the order of the items in the list may be based, for example, on relevance with respect to a search criterion or search criteria, numerical order, or alphabetical order. Navigation of the items may be cumbersome and a risk may exist that one or more items that have relevance to a task are overlooked, for example, by being buried within a long list.

As an example, to facilitate review of items in search results, a method can include structuring items in search results with respect to a tree structure. As an example, a tree structure may provide for organizing items returned from a search as a hierarchical set of folders, for example, which may be collapsible and expandable. For example, consider a module that structures items of a search akin to a file system that stores files in folders, sub-folders, etc. Such an approach to structuring search results may be adopted by a user familiar with a hierarchical file system (e.g., disk, directory, parent folder, child folder, file), which may thereby facilitate navigation of items in search results. As an example, items in search results may be marked, for example, for purposes of one or more further searches, downloads, tracking (e.g., search history), etc. As an example, a hierarchical tree structure may be re-ordered, for example, to rearrange search result item folders.

As an example, a tree structure may be referred to as a virtual tree, for example, that mimics a hierarchy of file system (e.g., nested folders). As an example, items in search results may be presented (e.g., rendered to a display) in virtual folders, for example, that mimic folders of a file system. As an example, one or more command, control, navigation, etc. technique in a virtual tree may be akin to one or more of those of a file system.

As an example, a framework that can organize models and associated data as projects may include a module for structuring items in search results. Such a module may, for example, create a dynamic, virtual tree based on one or more structuring criteria that form one or more levels of a hierarchy. For example, if a user selects the following structuring criteria “Project”, “Well Type” and “User”, results from a search may be presented in a virtual tree hierarchy that shows projects at a first level in the tree (per the “Project” criterion), where one or more project folders may be expanded to show well types as a second level (per the “Well Type” criterion), and where one or more well type folders may be expanded to show users as a third level (per the “User” criterion). In such an example, when a user opens up a folder for a specific project (e.g., project “A”), the user may then see a list of child nodes (e.g., child folders) for the well types in project A. In such an example, if the user then opens up a specific well type (e.g., “Oil”), the user may then see a list of users (e.g., child folders) that have modified the “Oil” wells in project “A”. Further, as an example, if the user then opens up a folder for a given user (e.g., user “B”), the user may see a list of oil wells in project A modified by user “B”.

As an example, the virtual tree structure may be dynamically controlled, for example, by re-ordering the levels, deleting a level, adding a level, etc. For example, a user may delete “Well Type” such that the search results are structured according to a new hierarchy with two levels (“Project” and “User”) rather than three levels. As an example, a user may re-order levels, for example, by dragging and dropping a graphical control for a level to position it before or after a graphical control for another level. For example, a user may drag and drop a “User” button to position it before (e.g., to the left of, above, etc.) a “Project” button (e.g., or vice versa) where, in response to repositioning, search results are restructured according to a hierarchy where the “User” level is before the “Project” level (e.g., the “Project” level is a child of the parent “User” level).

As an example, a graphical user interface (GUI) may be rendered to a display, for example, upon execution of code, where the GUI includes one or more graphical controls. For example, such a GUI may include a graphical control that provides a list of criteria for structuring results, for example, where individual criterion may be selected (e.g., via a dropdown menu, dragging and dropping, etc.). As an example, a structuring criterion may differ from a search criterion. For example, a user may search using a well criterion (e.g., wells with a depth of at least X meters) and then organize results using a structuring criterion (e.g., projects, age of wells, etc.) or, for example, organize results using both types of criteria. As an example, one or more criteria may be considered facets or filters, for example, which may become part of a tree hierarchy (e.g., one or more levels to a tree).

As an example, a structuring criterion may be an attribute, for example, an attribute associated with data. For example, “project” may be a structuring attribute associated with project data for a project or projects, which may be at a level that encompasses various other attributes for a project (e.g., as defined by a project framework). As an example, an attribute may be referred to as a path attribute, for example, akin to a path term in a file system.

As an example, a search tool can provide for returning structured data (e.g., exploration and production data “E&P data”) such as, for example, wells and seismic objects (e.g., as entities in a model, entities in a field, etc.). As an example, search results may be visualized in one or more 2D/3D canvases (e.g., panels rendered to a display) and, for example, optionally in a table viewer (e.g., in a table format). As an example, provided with one or more structuring criteria, search results may be presented according to such criteria (e.g., consider a path attribute akin to a folder path in a file system). For example, structuring criteria may specify hierarchical levels for nesting of search results where “folders” may be presented to a graphical user interface, the folders being expandable and collapsible with respect to the hierarchical levels. As an example, search results may be rendered to a graphical user interface on a display as an interactive tree of folder branches and search item leaves.

As an example, a folder (e.g., or other graphic) may be rendered to a display along with a number of items in the folder. For example, for a hierarchical level “Projects”, search results may include 50 items for Project A, 2 items for Project B and 1500 items for Project C. In such an approach, a user may readily ascertain how the search results are distributed with respect to the three projects. As an example, upon expanding a folder for Project C, subfolders may be presented along with numbers of items in each of the subfolders. For example, if the next level down is “Wells”, the 1500 items of the search results for Project A may appear as being distributed as follows: 1000 for a Well X folder, 400 for a Well Y folder and 100 for a Well Z folder. In such a manner, a user may readily ascertain how the search results are distributed for the three wells of Project A. As an example, ordering of sub-folders and/or items may optionally be via an alphabetical order, numerical order, etc. For example, a projects folder may be expanded to list sub-folders for projects ordered alphabetically by project name.

As an example, search results provided in a “virtual tree” manner may allow for user interaction with the search results, for example, to group hits into categories in a dynamic and hierarchical fashion. As an example, a result may be visualized in a tree view with “virtual” folder attributes, for example, based on one or more categories a user has selected.

As an example, a module (e.g., processor-executable instructions storable in a storage device) may provide for rendering of a user interface that allows a user specify <n> number of attributes where the <n> number of attributes (e.g., where “n” is an integer with a value of one or greater) may provide for grouping search results and optionally other functionality. For example, an algorithm of the module may provide for creating a tree model based on the selected attributes of the <n> number of attributes and based on “hits” as search results (e.g., matching or best matching items). A module may provide for rendering a tree as part of a graphical user interface (GUI) where a user can interact with and drill down into the tree based on, for example, categories for each selected attribute.

As an example, a system may include one or more processors, memory and processor executable instructions that can create a dynamic, virtual tree based on attributes of a search that provides search results and based on attributes selected by a user.

As an example, a search module may provide for searching via a search engine. As an example, the STUDIO E&P™ knowledge environment (Schlumberger Ltd., Houston, Tex.) includes STUDIO FIND™ search functionality, which provides a search engine. The STUDIO FIND™ search functionality also provides for indexing content, for example, to create one or more indexes. As an example, search functionality may provide for access to public content, private content or both, which may exist in one or more databases, for example, optionally distributed and accessible via an intranet, the Internet or one or more other networks. As an example, a search engine may be configured to apply one or more filters from a set or sets of filters, for example, to enable users to filter out data that may not be of interest.

As an example, a module may structure data from a search and present the data in a tree format suitable for use in conjunction with a graphical user interface (GUI) that allows for interactive navigation of search results.

As an example, the PETREL® seismic-to-simulation framework (Schlumberger Ltd., Houston, Tex.) may provide for interaction with a search engine and, for example, associated features such as features of the STUDIO FIND™ search functionality. As an example, a framework may provide for implementation of one or more spatial filters (e.g., based on an area viewed on a display, static data, etc.). As an example, a search may provide access to dynamic data (e.g., “live” data from one or more sources, optionally including a GIS source), which may be available via one or more networks (e.g., wired, wireless, etc.). As an example, one or more modules may optionally be implemented within a framework or, for example, in a manner operatively coupled to a framework (e.g., as an add-on, a plug-in, etc.). As an example, a module for structuring search results (e.g., in a hierarchical tree structure) may optionally be implemented within a framework or, for example, in a manner operatively coupled to a framework (e.g., as an add-on, a plug-in, etc.).

As an example of a system is described below, which may include a framework and associated components (e.g., modules, etc.), followed by examples of systems, methods, graphical user interfaces, etc.

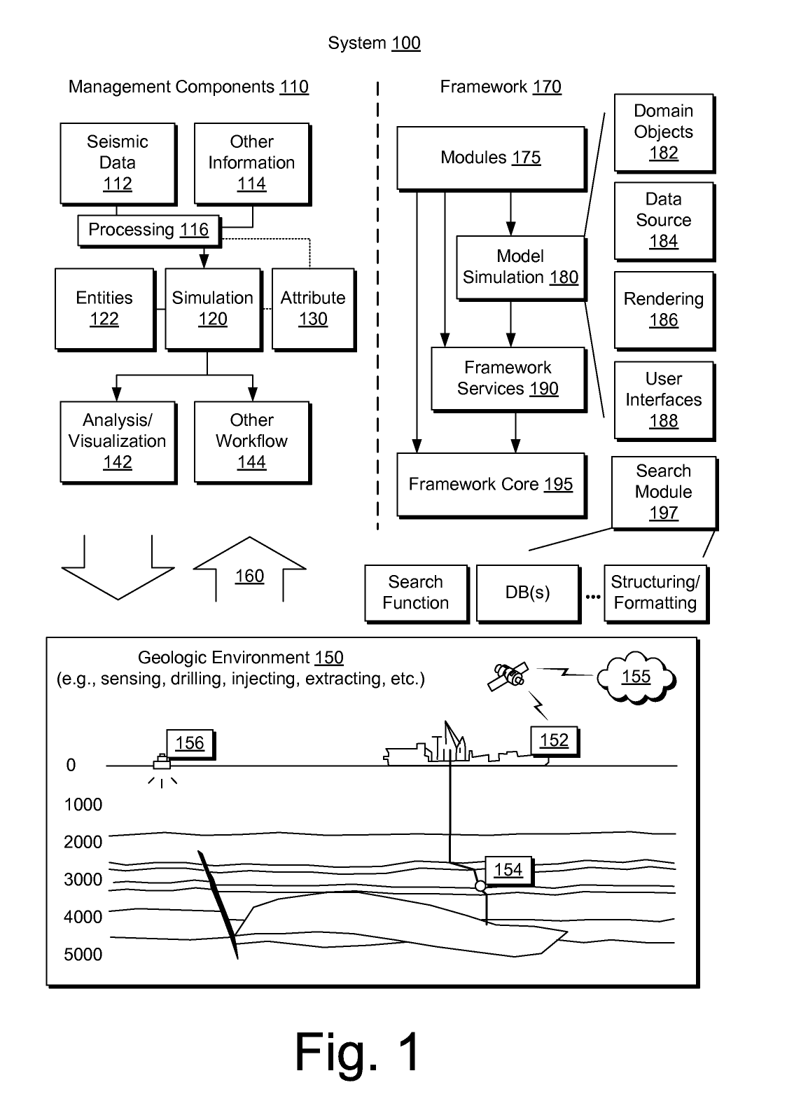

FIG. 1 shows an example of a system 100 that includes various management components 110 to manage various aspects of a geologic environment 150. For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an information component 114, a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include, for example, earth entities or geological objects such as wells, surfaces, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114).

In an example embodiment, the simulation component 120 may rely on a software framework such as an object-based framework. In such a framework, entities may include entities based on pre-defined classes to facilitate modeling and simulation. A commercially available example of an object-based framework is the MICROSOFT® .NET™ framework (Redmond, Wash.), which provides a set of extensible object classes. In the .NET™ framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes (e.g., including seismic attributes). Such processing may occur prior to input to the simulation component 120. Alternatively, or in addition to, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results. Additionally, or alternatively, output from the simulation component 120 may be input to one or more other workflows, as indicated by a workflow component 144.

In an example embodiment, the management components 110 may include features of the PETREL® seismic-to-simulation software framework. The PETREL® framework provides components that can allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of simulating a geologic environment).

In an example embodiment, the management components 110 may include features for geology and geological modeling to generate high-resolution geological models of reservoir structure and stratigraphy (e.g., classification and estimation, facies modeling, well correlation, surface imaging, structural and fault analysis, well path design, data analysis, fracture modeling, workflow editing, uncertainty and optimization modeling, petrophysical modeling, etc.). Particular features may allow for performance of rapid 2D and 3D seismic interpretation, optionally for integration with geological and engineering tools (e.g., classification and estimation, well path design, seismic interpretation, seismic attribute analysis, seismic sampling, seismic volume rendering, geobody extraction, domain conversion, etc.). As to reservoir engineering, for a generated model, one or more features may allow for a simulation workflow to perform streamline simulation, reduce uncertainty and assist in future well planning (e.g., uncertainty analysis and optimization workflow, well path design, advanced gridding and upscaling, history match analysis, etc.). The management components 110 may include features for drilling workflows including well path design, drilling visualization, and real-time model updates (e.g., via real-time data links).

In an example embodiment, various aspects of the management components 110 may include add-ons or plug-ins that operate according to specifications of a framework environment. For example, the framework environment marketed as the OCEAN® framework environment can allow for integration of add-ons (or plug-ins) into a PETREL® framework (e.g., for implementation in a workflow). The OCEAN® framework environment leverages .NET® tools (Microsoft Corporation, Redmond, Wash.). In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® seismic-to-simulation framework that can host OCEAN® framework applications.

The model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components (e.g., a user interface environment that aims to provide a relatively harmonious, comprehensible user experience).

In the example of FIG. 1, the domain objects 182 can include entity objects, property objects and optionally other objects. Entity objects may be used to geometrically represent wells, surfaces, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (e.g., data stores), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored, for example, using the model simulation layer 180, which can recreate instances of the relevant domain objects.

In the example of FIG. 1, a search module 197 may be provided that allows for integration with a search engine (e.g., the STUDIO FIND™ search engine), one or more databases, one or more structuring modules, one or more formatting modules, etc. In an example embodiment, the search module 197 may be part of the framework 170 and provide for “plugging-in” to one or more other modules (e.g., whether local or remote).

As an example, the search module 197 may receive data responsive to input from a pointing device (e.g., via a computer bus, network, wireless, etc. connection). In turn, the module 197 may communicate the data in appropriate form to a database server (e.g., via a network, whether wired or wireless), optionally in a manner specified by one or more application programming interfaces (APIs) associated with the database server. In response, the module 197 may receive information (e.g., via a network) from the database server (e.g., where the module 197 makes an API call and the server responds to the call according to a specification for the API). The module 197 may then process at least some of the information (e.g., structuring, formatting, etc.), which may be returned, for example, to process a workflow associated with the framework 170.

In the example of FIG. 1, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc.

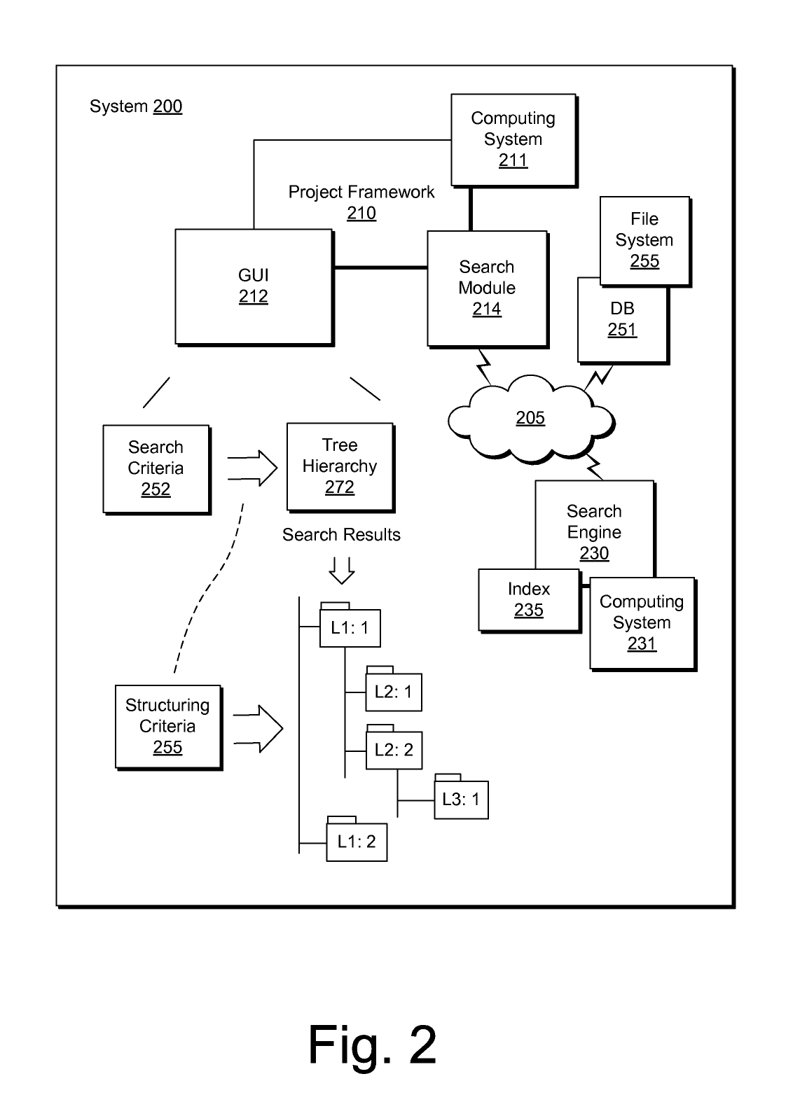

FIG. 2 shows an example of a system 200 that includes a computing system 211, a computing system 231, and a database 251 (e.g., including a server or servers) configured for communication via one or more networks 205. The computing system 211 provides for execution of a project framework 210 to present a GUI 212 and of a search module 214. Through interaction with the GUI 212, instructions and data may be transmitted by the module 214 via the network 205 to the computing system 231, which provides for execution of a search engine 230, which may operate according to an index 235. In turn, the computing system 231 may transmit information to the computing system 211. As an example, the index 235 may pertain to items stored in the database 251 according to a file system 255. As an example, the file system 255 may provide paths for items where the paths are organized in a hierarchical manner.

In the example of FIG. 2, a structuring criteria (SC) module 255 can provide for input of one or more structuring criteria for structuring search results (e.g., search results items) in a tree hierarchy 272. As an example, the module 255 may be operatively coupled to the GUI 212. As an example, the module 255 may provide a default hierarchy, which may be, for example, a user defined default hierarchy or, for example, a default hierarchy associated with a particular task, workstep, workflow, etc.

As an example, a user may enter search criteria 252 and perform a search that returns search results (e.g., items). As shown in the example of FIG. 2, the search results may be structured in the tree hierarchy 272 according to one or more structuring criteria 255. For example, the search results may be structured according to three levels: L1, L2 and L3. In such an example, L1 may include groupings L1:1 and L1:2 where L1:1 includes sub-groupings L2:1 and L2:2 and where L2:2 includes sub-grouping L3: 1. As an example, a tree hierarchy may be manipulated, browsed, navigated, etc., for example, via a graphical user interface. As an example, a number may appear with a group where the number indicates how many items exist within that group. For example, in FIG. 2, where 1000 search result items are returned responsive to the search, those may be divided between L1:1 and L1:2, for example, where L1:1 includes 700 of the search result items and where L1:2 includes 300 of the search result items. By presenting such numbers, a user may readily ascertain how the search result items are distributed for L1. As an example, numbers may also be presented for sub-levels (e.g., L2 and L3, as appropriate).

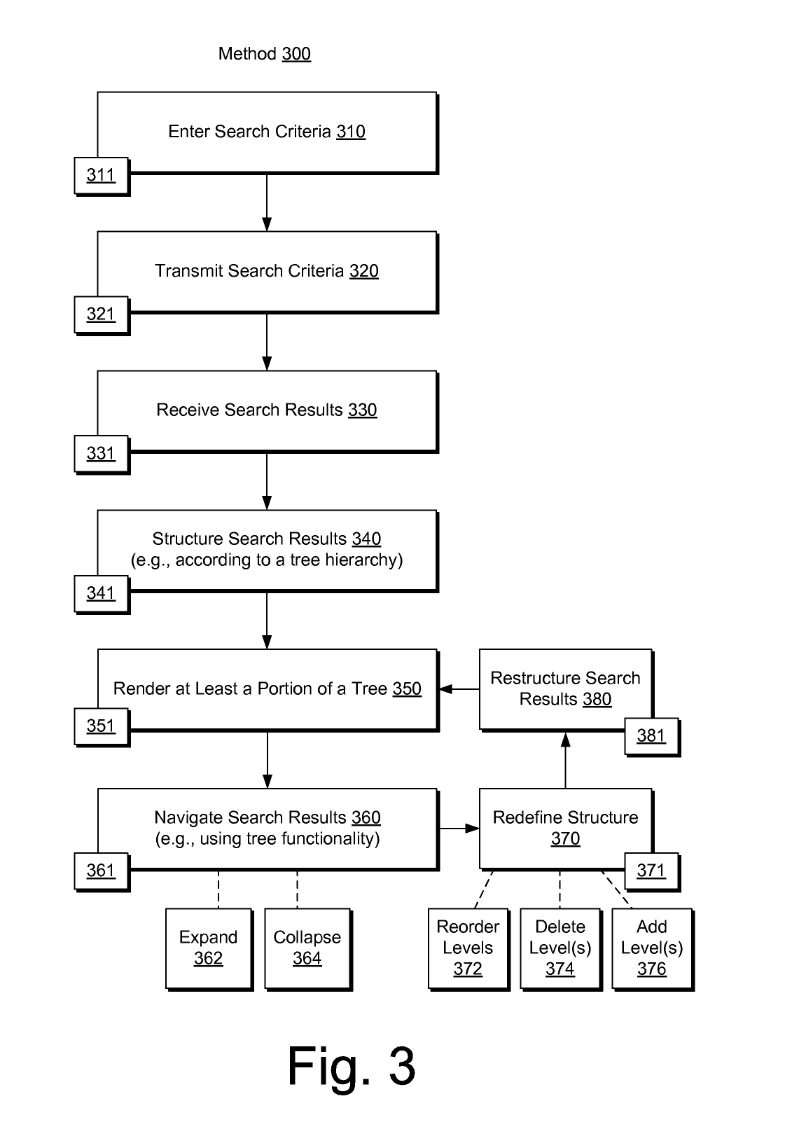

FIG. 3 shows an example of a method 300. The method 300 includes an entry block 310 for entering search criteria, a transmission block 320 for transmitting the search criteria, a reception block 330 for receiving search results based on the search criteria, a structure block 340 for structuring the search results based at least in part on a hierarchy defined by one or more structuring criteria, a render block 350 for rendering at least a portion of the hierarchy (e.g., as a graphic, etc. to a display) and a navigation block 360 for navigating the search results, for example, using a tree functionality where the tree functionality provides for navigating search results based at least in part on the hierarchy. As an example, per an expand block 362, navigating may include expanding a portion of a tree structure and, per a collapse block 364, navigating may include collapsing a portion of a tree structure.

As an example, the method 300 may include a redefinition block 370 for redefining a hierarchy (e.g., re-ordering levels per block 372, deleting a level per block 374, adding a level per block 376, etc.) and a restructuring block 380 for restructuring search results according to a redefined hierarchy. In turn, the method 300 may include rendering at least a portion of the redefined hierarchy (e.g., as a graphic, etc. to a display).

The method 300 is shown in FIG. 3 in association with various computer-readable media (CRM) blocks 311, 321, 331, 341, 351, 361, 371 and 381. Such blocks generally include instructions suitable for execution by one or more processors (or cores) to instruct a computing device or system to perform one or more actions. While various blocks are shown, a single medium may be configured with instructions to allow for, at least in part, performance of various actions of the method 300.

As an example, one or more computer-readable storage media can include computer-executable instructions to instruct a computing system to: receive search results for a search of data based on search criteria; structure the search results in a hierarchical tree structure defined by at least one structuring criterion; render a graphic of at least a portion of the hierarchical tree structure to a display; responsive to redefinition of the hierarchical tree structure, restructure the search results; and render a graphic of at least a portion of the redefined hierarchical tree structure to the display. In such an example, instructions may be included to render the graphic as at least one folder where, for example, the at least one folder may be an expandable and collapsible folder.

As an example, instructions may be provided to render a total number of items in search results and instructions to render a number of items in the search results associated with each branch of a hierarchical tree structure.

As an example, instructions may be provided to redefine a hierarchical tree structure. For example, to re-order levels of a hierarchical tree structure where each level is defined by a structuring criterion, to delete a level of a hierarchical tree structure where the level is defined by a structuring criterion, to add a level to a hierarchical tree structure where the level is defined by a structuring criterion, etc.

As an example, instructions may be provided to navigate a hierarchical tree structure at least in part by expanding branches of the hierarchical tree structure where each branch includes at least one leaf that represents an item in search results.

As an example, a method can include receiving search results for a search of data based on search criteria; structuring the search results in a hierarchical tree structure defined by at least one structuring criterion; rendering a graphical control to a display that comprises a graphic of at least a portion of the hierarchical tree structure; and navigating the search results by interacting with the graphical control. In such a method, the hierarchical tree structure may include levels where each level is defined by a structuring criterion.

As an example, a method may include navigating by redefining a hierarchical tree structure and restructuring search results according to the redefined hierarchical tree structure. As an example, redefining may include deleting a level of the hierarchical tree structure where the level corresponds to a structuring criterion, adding a level to a hierarchical tree structure where the level corresponds to a structuring criterion, re-ordering levels of a hierarchical tree structure where each of the levels corresponds to a structuring criterion.

As an example, a method may include rendering a graphic with numbers that indicate how many items in search results are associated with at least a portion of a hierarchical tree structure.

As an example, a system can include one or more processors; memory; and instructions stored in the memory and executable by at least one of the one or more processors to instruction the system to receive search results for a search of data based on search criteria, render a graphical control to a display for at least a first level of a hierarchical tree structure defined by structuring criteria, and, responsive to selection of the graphical control, render one or more additional graphical controls to the display as one or more branches of the hierarchically tree structure where each of the one or more branches is defined by one of the structuring criteria. As an example, such a system may search data that includes project data associated with a seismic-to-simulation framework.

As an example, a system may include instructions to instruct the system to render a number that represents a number of search results for a level of a hierarchical tree structure. As an example, a system may include instructions to instruct the system to redefine the hierarchical tree structure by at least one of re-ordering the structuring criteria, deleting at least one of the structuring criteria and adding another structuring criterion.

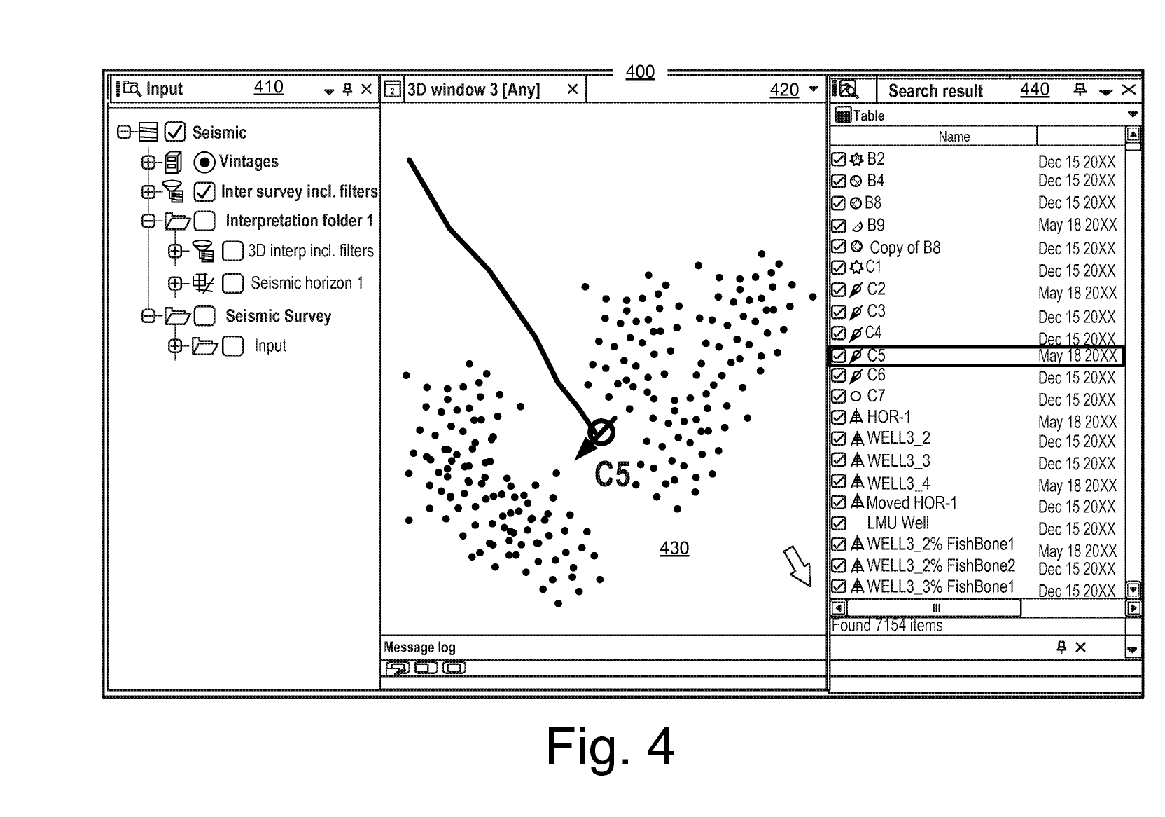

FIG. 4 shows an example of a graphical user interface (GUI) 400 for a project in a project framework (e.g., the PETREL® framework). In the GUI 400 of FIG. 4, selectable search criteria 410 are presented in a tree hierarchy. For example, under a criterion level “Seismic Survey” there is another criterion level “Input”, which may, for example, be organized by yet another criterion level “number” (e.g., year). In the example of FIG. 4, the GUI 400 includes an E&P canvas 420 (e.g., a panel or window), one or more search results 430 in the canvas 420 and a table view of search results 440. As an example, the GUI 400 of FIG. 4 may be implemented in an E&P application with a search filter module, a search results module and a 3D visualization canvas module. As shown in FIG. 4, selection of well “C5” in the search results shows the model data for the well “C5” in the canvas 430.

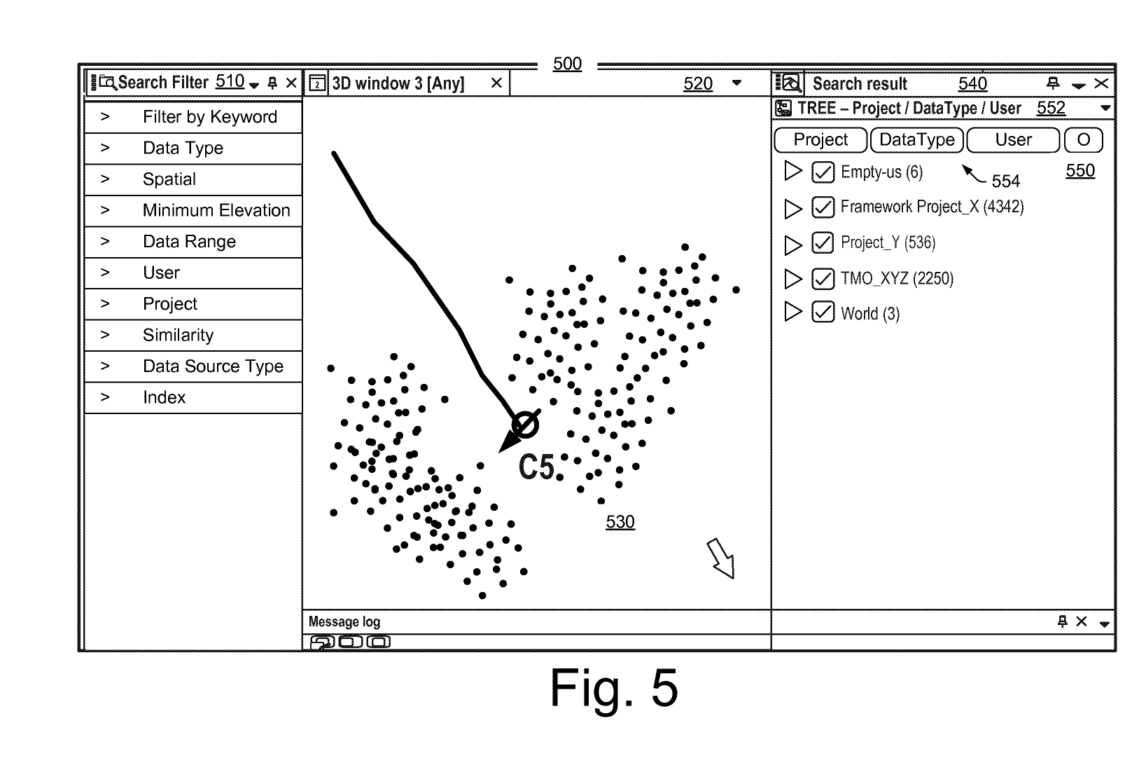

FIG. 5 shows an example of a graphical user interface (GUI) 500 for a project in a project framework (e.g., the PETREL® framework). In the GUI 500 of FIG. 5, selectable search criteria 510 are presented as search filters. For example, options can include filter by keyword, data type, spatial, minimum elevation, data range, user, project, similarity, data source type and index. In the example of FIG. 5, the GUI 500 includes an E&P canvas 520, search results 530 in the canvas 520, a tree view of search results 540 and selectable graphical controls 550 for aid in structuring and navigating results optionally in conjunction with direct selection of results (see, e.g., check boxes as well as arrows, which may provide for extending branch or branches of a tree). As an example, the GUI 500 of FIG. 5 may be implemented in an E&P application with a search filter module, a search results module configured to present results in a hierarchical tree structure and a 3D visualization canvas module.

In the example of FIG. 5, a user may have selected or switched to a virtual tree viewer option, for example, that specifies a list of attributes (e.g., structuring criteria) to categorize and structure search results. As an example, with the virtual tree viewer option, upon performing a search, a user may see at a glance that there are 2250 hits in the project “TMO_XYZ” (see checked box for “TMO_XYZ” in search results 540).

As shown in the example of FIG. 5, the selectable graphical controls 550 include at least one control 554 for selecting a structuring criterion. For example, the “O” button may be selected such that a menu is rendered to a display that lists possible structuring criteria. For example, such a menu may list “Project”, “DataType” and “User”. As an example, a field 552 may display an order for structuring criteria where that order corresponds to levels of a hierarchical tree structure. For example, as shown, the field 552 displays “Project/DataType/User” as a structuring criteria order (e.g., a structuring criteria “path”), which has a form akin to that of a file path in a file system. As an example, a user may re-order structuring criteria, delete a structuring criterion, add a structuring criterion, etc. where, in response, the field 552 updates display of the structuring criteria order. As an example, re-ordering may be performed by dragging and dropping graphical controls associated with levels (e.g. structuring criteria).

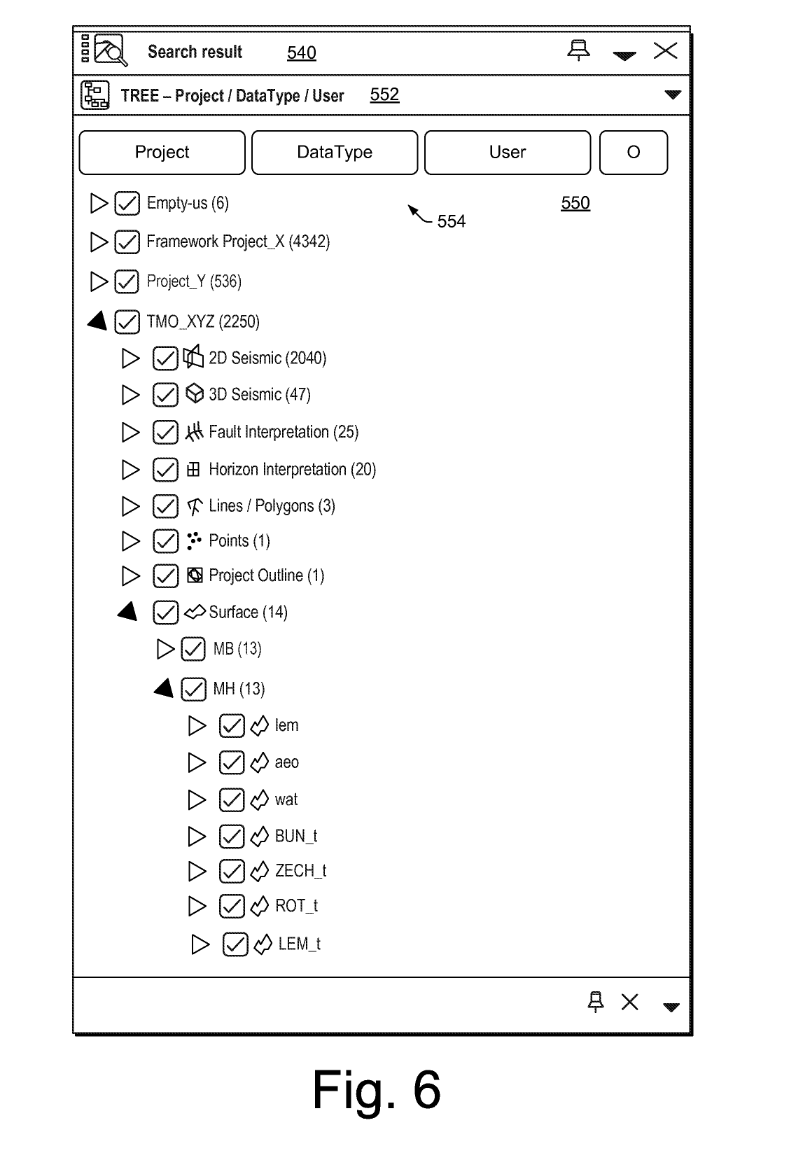

FIG. 6 shows a portion of the GUI 500 of FIG. 5 where the tree has been expanded for the project “TMO_XYZ” to reveal additional branches, for example, extending to an object level (e.g., entity level as a data type), user level, etc., for the project (e.g., according to data storage paths for data associated with each level). In the example of FIG. 6, the number of results for each “category” is shown. At a glance, a user may readily ascertain a “breakdown” as to the types of information, objects, users, etc., associated with a project. For example, in the FIG. 6, a user can now see a breakdown of the project “TMO_XYZ” based on data type (e.g., 14 surfaces), and then again based on which users have modified the surfaces (e.g., “MH” to indicate that user “H” has modified one or more surfaces). In the example of FIG. 6, upon selection of one or more items in the search results, a panel of a GUI may render the selected one or more items, for example, with highlighting, labels, etc.

As an example, a module may receive file system information responsive to a search and parse the information to construct a hierarchy for presentation of search results. For example, where data exists at a remote site, portions of a file path may be stripped. Further, where data exists at multiple sites, a module may harmonize file path information to allow for a uniform view of the data (e.g., as search results) without any indication that the data exists at different sites. For example, if a large project includes data stored at multiple sites where the data is indexed in an index of a search engine, when the search engine matches items in the index to the search criteria, file paths for the items may be processed, organized, etc., in manner (e.g., by a module) that allows for a uniform presentation of search results in a hierarchical tree manner (see, e.g., FIG. 6).

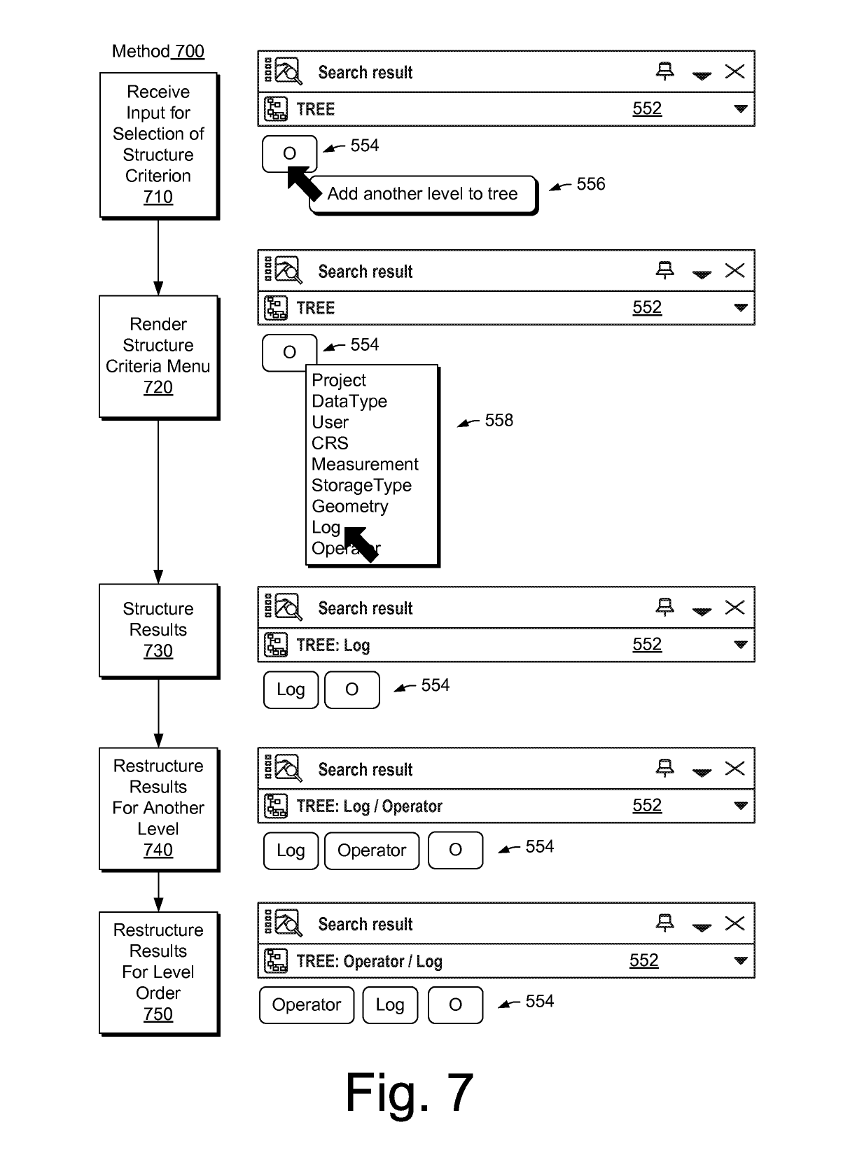

FIG. 7 shows an example of a method 700 along with various example graphics, for example, where reference is made to various features of the GUI 500 of FIG. 5. As shown, the method 700 includes a reception block 710 for receiving input for selection of a structure criterion, a render block 720 for rendering a structure criteria menu, a restructure block 730 for structuring search results according to at least one selected structure criterion, a restructure block 740 for restructuring the search results responsive to selection of another structure criterion (e.g., for another level of a hierarchical tree structure) and a restructure block 750 for restructuring the search results responsive to re-ordering of structuring criteria (e.g., for re-ordering of levels).

As the features of the GUI 500, in the example of FIG. 7, the “O” control may be presented as one of the controls 554 and may be selected to “add another level to tree” per a message window 556 (e.g., an optional hint). Responsive to selection of the “O” control, a menu 558 may be rendered to a display that includes a list of possible structuring criteria (e.g., project, datatype, user, etc.). As shown, “Log” may be selected as a structuring criterion and a graphical control may be rendered to the display as well as the field 552 updated to reflect the selection of “Log”. Results may be rendered as well, for example, using an expandable and collapsible tree graphic. As shown in the example of FIG. 7, an additional structuring criterion may be added as a level to a hierarchical tree structure, for example, consider the entry “Operator” in the menu 558 where the field 552 is updated to indicate an order of levels. Further, as shown in the example of FIG. 7, the levels may be re-ordered, for example, to place “Operator” prior to “Log”. In such a manner, a tree may be presented as collapsible and expandable graphical controls that can expand and contract branches of the tree for the re-ordered levels (e.g., rather than “Operator” as a branch of “Log”, “Log” is now a branch of “Operator”).

As an example, a framework may include a data environment that may be managed by a search module, for example, via a data environment manager (DEM). As an example, a DEM may provide for managing data via a plug-in. For example, a well data plug-in may enable a user to index well data and, for example, include one or more attributes for the well data in an attribute list. As an example, well data may be provided via a well data platform such as, for example, the Techlog™ platform (Schlumberger Limited, Houston, Tex.). Such a platform may allow for integration of wellbore data. As an example, a workflow may include one or more worksteps associated with a well data platform (e.g., for analyses of cores, calibrating log interpretations, evaluating pressures, resistivity logs, capillary pressure measurements, derivation of a saturation height model, etc.).

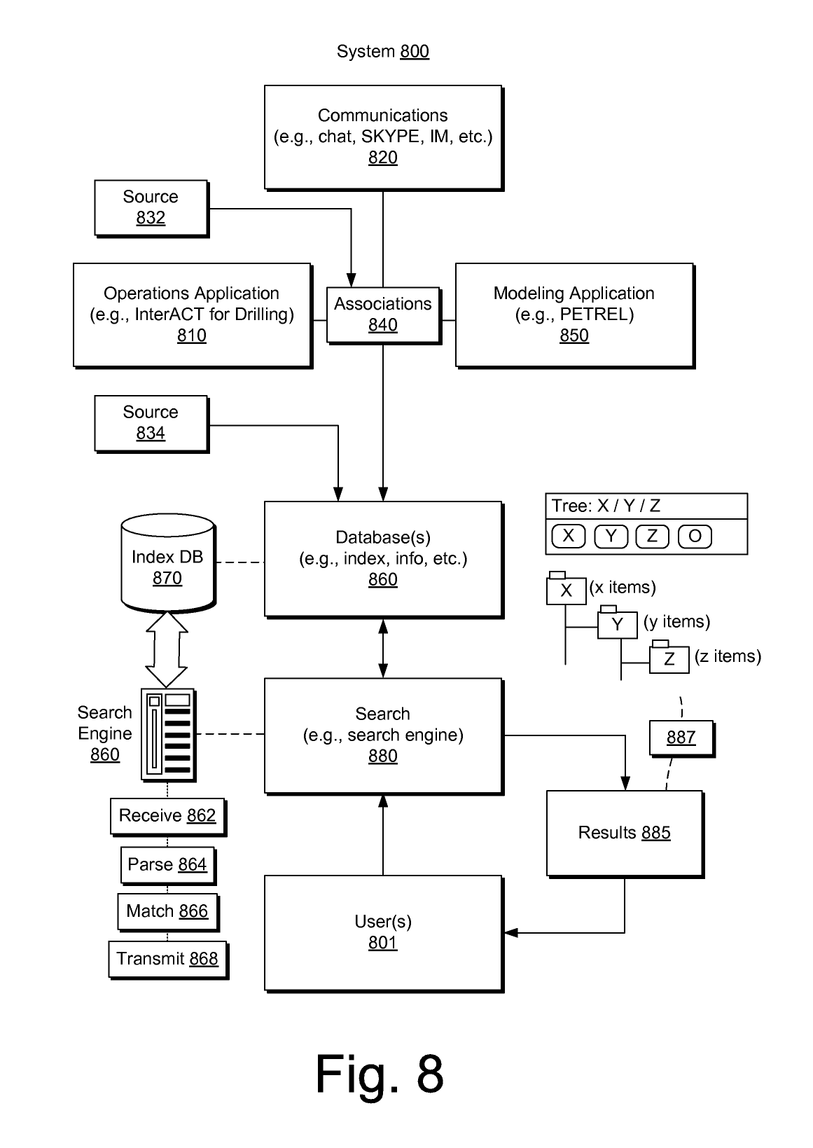

FIG. 8 shows an example of a system 800 that includes a search engine 860 and an index database 870. As an example, the index database 870 may provide an index where a GUI may include a query field for entry of a query and a control for transmission of the query to the search engine 860 (e.g., a server or other computing device or system) where the search engine 860 may include a reception module 862 to receive a query, a parse module 864 to parse the query, a match module 866 to search for one or more matches (e.g., to information, terms, etc., included in the query) and a transmission module 868 to transmit at least one of the one or more matches for presentation as results in a results GUI. In such an example, a results structuring module 887 may structure items in search results in a hierarchical manner, for example, akin to files and folders.

In the example of FIG. 8, the system 800 includes an operations application module 810, a communications module 820, source modules 832 and 834, an associations module 840, a modeling application module 850, a database module 860, and a search index module 880. The modules 810, 820, 832, 834 and 850 may provide access to various sources of information. As an example, a system may include one or more such modules, for example, to provide access to one or more sources of information.

In the example of FIG. 8, a user module 801 provides for one or more users to enter one or more search terms, criteria, etc., to the search index module 880 where the index search module 880 can return one or more results (e.g., items) per a results module 885 (e.g., or an indication that no results match the search). In the example of FIG. 8, associations may be made by the associations module 840 based on such types of information and associated information may be stored in one or more databases per the database module 860. Such information may be indexed for purposes of searching per the search index module 880. As additional information is generated in one or more of the operations application module 810, the communications module 820, the modeling application module 850, the search index module 880 may perform additional indexing to update an index, for example, to dynamically enrich the search capabilities.

In the example of FIG. 8, an index approach to search can enhance performance in finding relevant documents responsive to a query. The search index module 880 may include search engine functionality for indexing where indexing may include collecting, parsing, and storing data to facilitate information retrieval.

As shown in the example of FIG. 8, the module 887 may structure results in a hierarchical manner, for example, according to a first level X, a second level Y and a third level Z. In such an example, a control may provide for deletion of a level, addition of a level and, for example, re-ordering of levels. A graphical user interface (GUI) may present a graphic that indicates an order of levels, which may change responsive to a user re-ordering the levels (e.g., drag and drop), deleting a level (e.g., right click or other command), adding a level (e.g., via selection of the “O” button to render a menu with selectable criteria), etc. For example, a computing system may receive a command to delete the level Y and, in response, render a graphic that indicates a new order of levels as being “X/Z”. In such an example, search results may be restructured in a hierarchy according to the new order of levels where Z criterion folders appear on a branch below X criterion folders. As an example, the module 887 may allow a user to navigate search results via ordering according to one or more structure criteria.

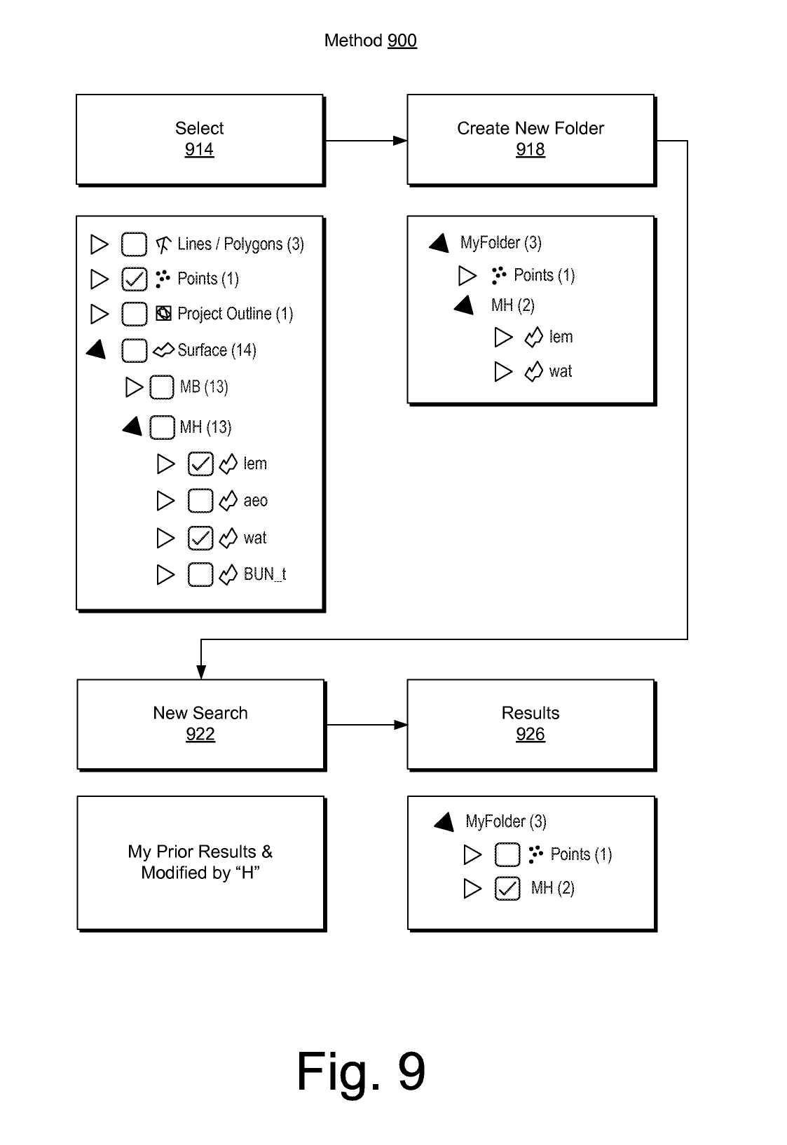

FIG. 9 shows an example of a method 900 that includes a selection block 914 for selecting one or more items in search results presented in a hierarchical tree structure, a creation block 918 for creating a new folder (e.g., a folder construct) for at least one of the selected items in the search results, a new search block 922 for performing new search (e.g., according to search criteria) and a results block 926 for presenting (e.g., organizing) one or more items from the new search. In the example of FIG. 9, a folder entitled “MyFolder” is shown as including items relevant to the search criteria. For example, the “MyFolder” may have been created as a new folder and then returned responsive to performing a new search. In such an example, a user may readily identify items in search results that have been previously returned in a prior search. Such an approach may facilitate focusing in on results for one or more purposes. As an example, such an approach may provide for tracking search history, for example, according to selections made by a user (e.g., folders created by a user to track progression of items in successive searches). As an example, one or more search items may be tagged, for example, to include an associated attribute (e.g., a “MyFolder” attribute, etc.). As an example, successive tagging may optionally be performed, for example, in a manner that may automatically increment an attribute (e.g., “MyHistory-1”, “My-History-2”, etc.). Such an approach may facilitate review, organization, etc. of results.

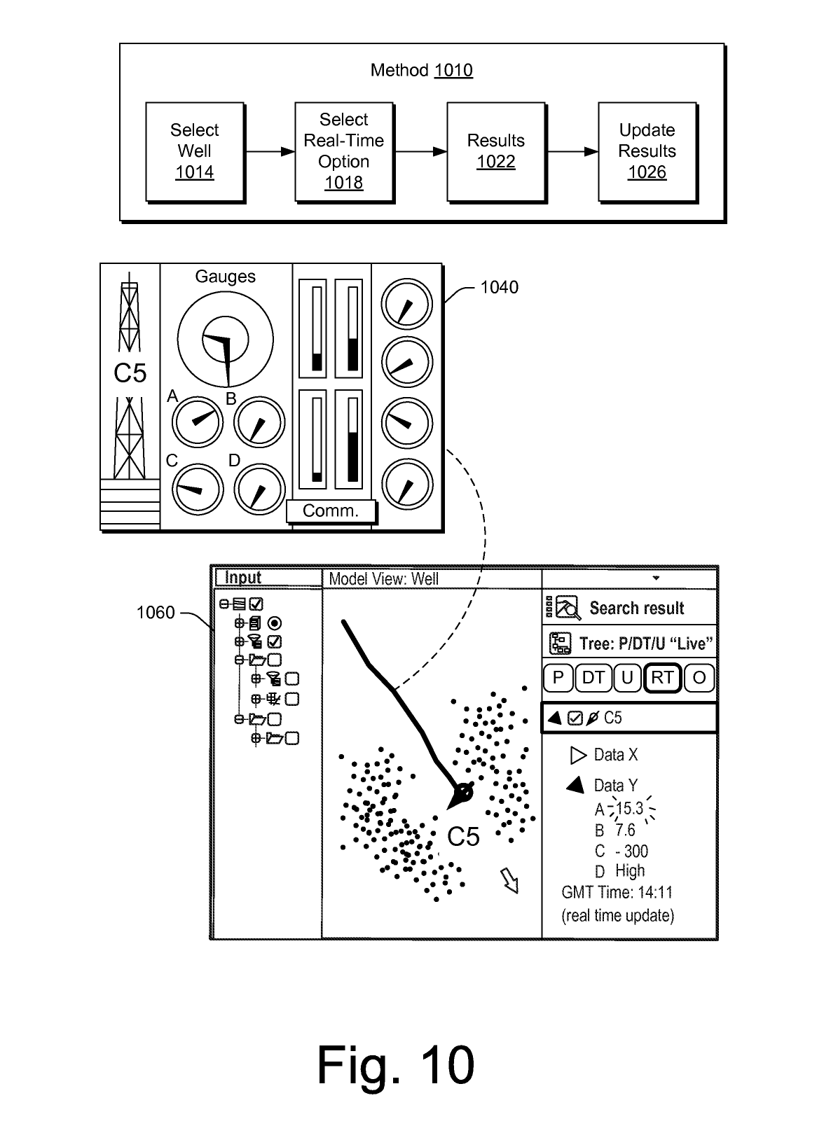

FIG. 10 shows an example of a method 1010 that includes a selection block 1014 for selecting a well, a selection block 1018 for selecting a real-time option (RT), a results block 1022 for presenting results and an update block 1026 for updating results (e.g., updating values for one or more items in search results).

In the example of FIG. 10, a well data graphical user interface (GUI) 1040 is shown, for example, as associated with a well data platform, and a framework graphical user interface (GUI) 1060 is shown, for example, as associated with a project framework (e.g., for modeling, etc.). In such an example, a user may select an item in search results such as a well (see, e.g., “C5”) where the well data platform is actively acquiring data for the well (see, e.g., gauges in the GUI 1040). As an example, as provided by a real-time option, search results may be updated, for example, responsive to receipt of newly acquired data. As an example, a results canvas that presents items in a hierarchical manner may highlight an item (e.g., or a folder) upon receipt of updated data. For example, for gauges A, B, C and D of the GUI 1040 that pertain to the well C5, as data are acquired, they may be transmitted for presentation in a search results canvas of the GUI 1060, for example, while a model representation of the well C5 is rendered to a model view canvas of the GUI 1060.

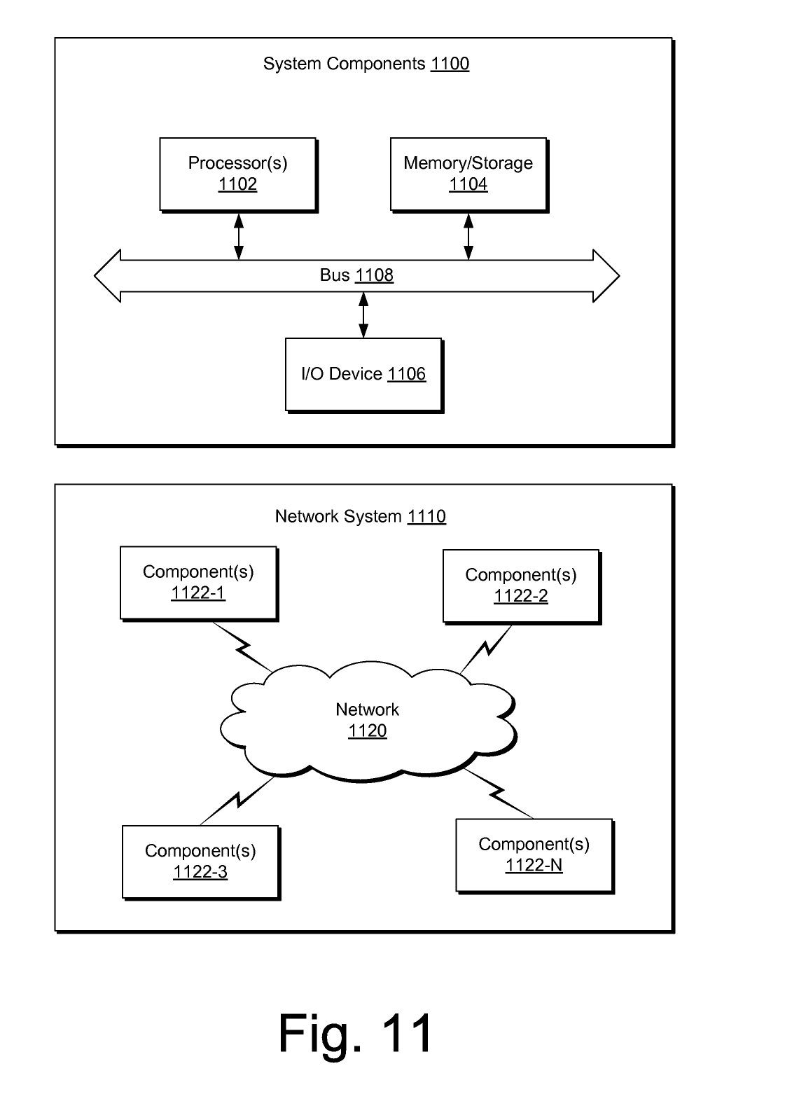

FIG. 11 shows components of an example of a computing system 1100 and an example of a networked system 1110. The system 1100 includes one or more processors 1102, memory and/or storage components 1104, one or more input and/or output devices 1106 and a bus 1108. In an example embodiment, instructions may be stored in one or more computer-readable media (e.g., memory/storage components 1104). Such instructions may be read by one or more processors (e.g., the processor(s) 1102) via a communication bus (e.g., the bus 1108), which may be wired or wireless. The one or more processors may execute such instructions to implement (wholly or in part) one or more modules, components, etc. (e.g., as part of a method). A user may view output from and interact with a process via an I/O device (e.g., the device 1106). In an example embodiment, a computer-readable medium may be a storage component such as a physical memory storage device, for example, a chip, a chip on a package, a memory card, etc.

In an example embodiment, components may be distributed, such as in the network system 1110. The network system 1110 includes components 1122-1, 1122-2, 1122-3, . . . 1122-N. For example, the components 1122-1 may include the processor(s) 1102 while the component(s) 1122-3 may include memory accessible by the processor(s) 1102. Further, the component(s) 1102-2 may include an I/O device for display and optionally interaction with a method. The network may be or include the Internet, an intranet, a cellular network, a satellite network, etc.

As an example, a device may be a mobile device that includes one or more network interfaces for communication of information. For example, a mobile device may include a wireless network interface (e.g., operable via IEEE 802.11, ETSI GSM, BLUETOOTH®, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words “means for” together with an associated function.

What is claimed is:

1. One or more computer-readable storage media comprising computer-executable instructions to instruct a computing system to:
receive search results for a search of data based on search criteria;
structure the search results in a hierarchical tree structure defined by at least one structuring criterion;
render a graphic of at least a portion of the hierarchical tree structure to a display;
responsive to redefinition of the hierarchical tree structure, restructure the search results; and
render a graphic of at least a portion of the redefined hierarchical tree structure to the display.

2. The one or more computer-readable storage media of claim 1 comprising instructions to render the graphic as at least one folder.

3. The one or more computer-readable storage media of claim 2 wherein the at least one folder comprises an expandable and collapsible folder.

4. The one or more computer-readable storage media of claim 1 comprising instructions to render a total number of items in the search results and instructions to render a number of items in the search results associated with each branch of the hierarchical tree structure.

5. The one or more computer-readable storage media of claim 1 comprising instructions to redefine the hierarchical tree structure.

6. The one or more computer-readable storage media of claim 5 wherein the instructions to redefine the hierarchical tree structure comprise instructions to re-order levels of the hierarchical tree structure wherein each level is defined by a structuring criterion.

7. The one or more computer-readable storage media of claim 5 wherein the instructions to redefine the hierarchical tree structure comprise instructions to delete a level of the hierarchical tree structure wherein the level is defined by a structuring criterion.

8. The one or more computer-readable storage media of claim 5 wherein the instructions to redefine the hierarchical tree structure comprise instructions to add a level to the hierarchical tree structure wherein the level is defined by a structuring criterion.

9. The one or more computer-readable storage media of claim 1 comprising instructions to navigate the hierarchical tree structure at least in part by expanding branches of the hierarchical tree structure wherein each branch comprises at least one leaf that represents an item in the search results.

10. A method comprising:
receiving search results for a search of data based on search criteria;
structuring the search results in a hierarchical tree structure defined by at least one structuring criterion;
rendering a graphical control to a display that comprises a graphic of at least a portion of the hierarchical tree structure; and
navigating the search results by interacting with the graphical control.

11. The method of claim 10 wherein the hierarchical tree structure comprises levels wherein each level is defined by a structuring criterion.

12. The method of claim 10 wherein the navigating comprises redefining the hierarchical tree structure and restructuring the search results according to the redefined hierarchical tree structure.

13. The method of claim 12 wherein redefining the hierarchical tree structure comprises deleting a level of the hierarchical tree structure wherein the level corresponds to a structuring criterion.

14. The method of claim 12 wherein redefining the hierarchical tree structure comprises adding a level to the hierarchical tree structure wherein the level corresponds to a structuring criterion.

15. The method of claim 12 wherein redefining the hierarchical tree structure comprises re-ordering levels of the hierarchical tree structure wherein each of the levels corresponds to a structuring criterion.

16. The method of claim 10 further comprising rendering the graphic with numbers that indicate how many items in the search results are associated with the at least a portion of the hierarchical tree structure.

17. A system comprising:
one or more processors;
memory; and
instructions stored in the memory and executable by at least one of the one or more processors to instruction the system to
receive search results for a search of data based on search criteria,
render a graphical control to a display for at least a first level of a hierarchical tree structure defined by structuring criteria, and
responsive to selection of the graphical control, render one or more additional graphical controls to the display as one or more branches of the hierarchically tree structure wherein each of the one or more branches is defined by one of the structuring criteria.

18. The system of claim 17 wherein the data comprise project data associated with a seismic-to-simulation framework.

19. The system of claim 17 further comprising instructions to instruct the system to render a number that represents a number of search results for a level of the hierarchical tree structure.

20. The system of claim 17 further comprising instructions to instruct the system to redefine the hierarchical tree structure by at least one of re-ordering the structuring criteria, deleting at least one of the structuring criteria and adding another structuring criterion.
